(19) United States
(12) Patent Application Publication
(10) Pub. No.: US 2022/0383073 A1
(43) Pub. Date: Dec. 1, 2022

(54) DOMAIN ADAPTATION USING DOMAIN-ADVERSARIAL LEARNING IN SYNTHETIC DATA SYSTEMS AND APPLICATIONS

(71) Applicant: NVIDIA Corporation, Santa Clara, CA (US)

(72) Inventors: David Jesus Acuna Marrero, Toronto (CA); Sanja Fidler, Toronto (CA); Marc Law, Toronto (CA); Guojun Zhang, Waterloo (CA)

(21) Appl. No.: 17/827,141

(22) Filed: May 27, 2022

Related U.S. Application Data
(60) Provisional application No. 63/194,697, filed on May 28, 2021.

(51) Int. Cl. G06N 3/04; G06N 3/08

(52) U.S. Cl. CPC G06N 3/0454; G06N 3/08

(57) ABSTRACT

In various examples, machine learning models (MLMs) may be updated using multi-order gradients in order to train the MLMs, such as at least a first order gradient and any number of higher-order gradients. At least a first of the MLMs may be trained to generate a representation of features that is invariant to a first domain corresponding to a first dataset and a second domain corresponding to a second dataset. At least a second of the MLMs may be trained to classify whether the representation corresponds to the first domain or the second domain. At least a third of the MLMs may trained to perform a task. The first dataset may correspond to a labeled source domain and the second dataset may correspond to an unlabeled target domain. The training may include transferring knowledge from the first domain to the second domain in a representation space.

### CROSS-REFERENCE TO RELATED APPLICATIONS

This application claims the benefit of U.S. Provisional Application No. 63/194,697, filed on May 28, 2021, the contents of which are hereby incorporated by reference in their entirety.

### BACKGROUND

Unsupervised domain adaptation (UDA) accounts for a lack of labeled data in a target domain by transferring knowledge from a labeled source domain (e.g., a related dataset with a different distribution where abundant labeled data already exists). Domain-adversarial learning (DAL) is a form of UDA which involves learning domain invariant representations of inputs in an adversarial fashion. DAL may aim to fool a classifier that operates in a representation space to classify whether a data point belongs to either the source or the target domain. More formally, DAL may be understood as training to minimize the discrepancy between the source and the target domain in a representation space.

In training neural networks, optimizers may be used to define how to change the parameters of the neural networks, such as weights and learning rate, in order to reduce loses according to a loss function. DAL conventionally implements optimizers that are based on gradient descent, which is a first-order optimization algorithm dependent on the first order derivative of a loss function. In DAL, the adversarial nature of the learning algorithm may result from the introduction of a gradient reversal layer (GRL). During backpropagation, the GRL may take the gradient from the subsequent level and change its sign—e.g., multiply the gradient by −1—before passing it to the preceding layer. While DAL is theoretically capable of high performance, in practice, DAL may be noticeably unstable and difficult to implement for use in training neural networks.

### SUMMARY

Embodiments of the present disclosure relate to optimizers having enhanced convergence for competing neural network components. More specifically, the disclosure relates to approaches for determining parameter values of neural networks while avoiding potential problems associated with gradient-based optimization algorithms that may cause instability in training or otherwise limit training performance.

In contrast to conventional approaches, such as those described above, to train machine learning models (MLMs), values of parameters of the MLMs may be updated based at least on multi-order gradients corresponding to one or more cost functions. For example, the values may be updated based at least on a first order gradient and any number of higher-order gradients. The MLMs may be trained using adversarial learning, for example, by jointly training the MLMs. At least a first of the MLMs may be trained to generate a representation of one or more features that is invariant to a first domain corresponding to a first dataset and a second domain corresponding to a second dataset. At least a second of the MLMs may be trained to classify whether the representation corresponds to the first domain or the second domain. At least a third of the MLMs may be trained to perform a task—such as to classify an object represented in input data—using one or more ground-truth labels assigned to the first dataset. In at least one embodiment, the first dataset may correspond to a labeled source domain (e.g., corresponding to renderings of three-dimensional models) and the second dataset may correspond to an unlabeled target domain (e.g., corresponding to real-world images). The training may include transferring knowledge from the first domain to the second domain in a representation space.

### BRIEF DESCRIPTION OF THE DRAWINGS

The present systems and methods for optimizers having enhanced convergence for competing neural network components are described in detail below with reference to the attached drawing figures, wherein:

FIG. 1 is an illustration of an example process that may be used to train one or more machine learning models, in accordance with some embodiments of the present disclosure;

FIG. 2 illustrates examples of machine learning models and associated datasets which may be used in domain-adversarial learning, in accordance with some embodiments of the present disclosure;

FIG. 3A illustrates an example of a dataset distribution of a source domain, in accordance with some embodiments of the present disclosure;

FIG. 3B illustrates an example of a dataset distribution of a target domain, in accordance with some embodiments of the present disclosure;

FIG. 4 is an example graph of parameter values in jointly trained neural networks for various forms of optimizers, in accordance with some embodiments of the present disclosure;

FIG. 5 is a flow diagram showing a method for training one or more MLMs using at least a first gradient and a second gradient, in accordance with some embodiments of the present disclosure;

FIG. 6 is a flow diagram showing a method for jointly training MLMs using at least a first gradient and a second gradient, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

The present disclosure relates to optimizers having enhanced convergence for competing neural network components. More specifically, the disclosure relates to approaches for determining parameter values of neural networks while avoiding potential problems associated with gradient-based optimization algorithms that may cause instability in training or otherwise limit training performance.

Disclosed approaches provide for gradient-based optimization of parameters of neural networks, where values of the parameters are updated based at least on multi-order gradients corresponding to one or more cost functions. For example, the values may be updated based at least on a first order gradient and any number of higher-order gradients. In at least one embodiment, one or more samples may be applied to one or more neural networks having first values of one or more parameters to generate one or more outputs. For example, the one or more neural networks may include a plurality of neural networks that are to be trained using adversarial learning (or more generally neural network components being trained for competing tasks or functions). The one or more outputs may be used to compute at least a first gradient and a second gradient corresponding to the one or more cost functions, with the second gradient having a higher order than the first gradient. The first values may be adjusted using the first gradient and the second gradient to determine second values of the one or more parameters for the one or more neural networks. In at least one embodiment, the adjustment may be based at least on a statistical combination (e.g., average) of at least the first gradient and the second gradient. The one or more neural networks may be trained using the second values of the one or more parameters.

In one or more embodiments, updating the values of the one or more parameters using multi-order gradients may ameliorate many potential problems that may arise in training neural networks using gradient-based optimization algorithms, such as gradient descent. For example, using gradient descent to optimize parameters for a network network(s) that includes a gradient reversal layer (GRL), such as in domain adversarial learning (DAL), may violate asymptotic convergence guarantees to a local Nash equilibria unless an upper bound is placed on the learning rate. Using higher-order gradients can effectively counteract the properties of gradient-based optimization algorithms that cause the upper bound. Thus, more aggressive learning rates may be used while achieving faster convergence.

In at least one embodiment, a plurality of neural networks may be jointly trained and include one or more first neural networks trained to generate a representation of one or more features that is invariant to a first domain corresponding to a first dataset and a second domain corresponding to a second dataset. The neural networks may also include one or more second neural networks to classify whether the representation corresponds to the first domain or the second domain. The neural networks may further include one or more third neural networks trained to classify the representation (the training may use one or more ground-truth labels assigned to samples in the first dataset). In at least one embodiment, the first dataset may correspond to a labeled source domain (e.g., corresponding to renderings of three-dimensional models) and the second dataset may correspond to an unlabeled target domain (e.g., corresponding to real-world images). The training may include transferring knowledge from the first domain to the second domain in a representation space learned by the neural networks.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

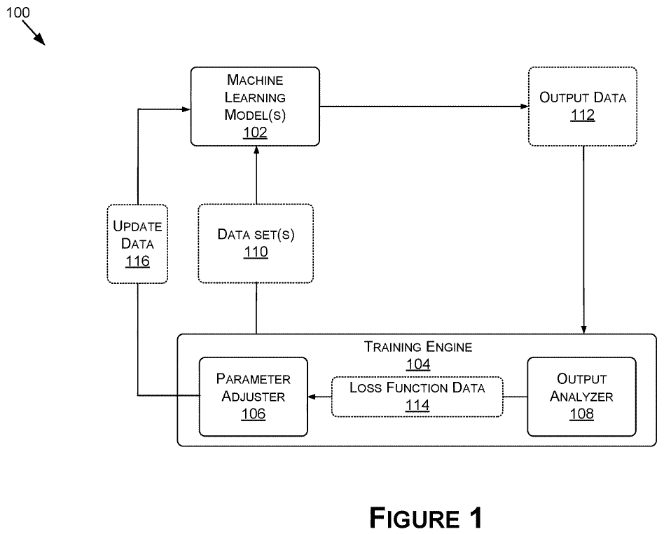

FIG. 1 is an illustration of an example process 100 that may be used to train one or more machine learning models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

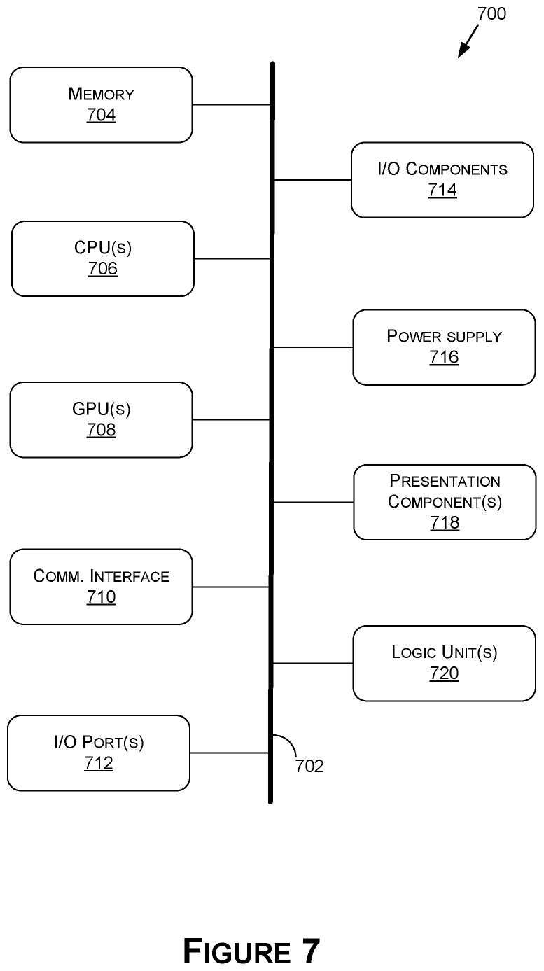

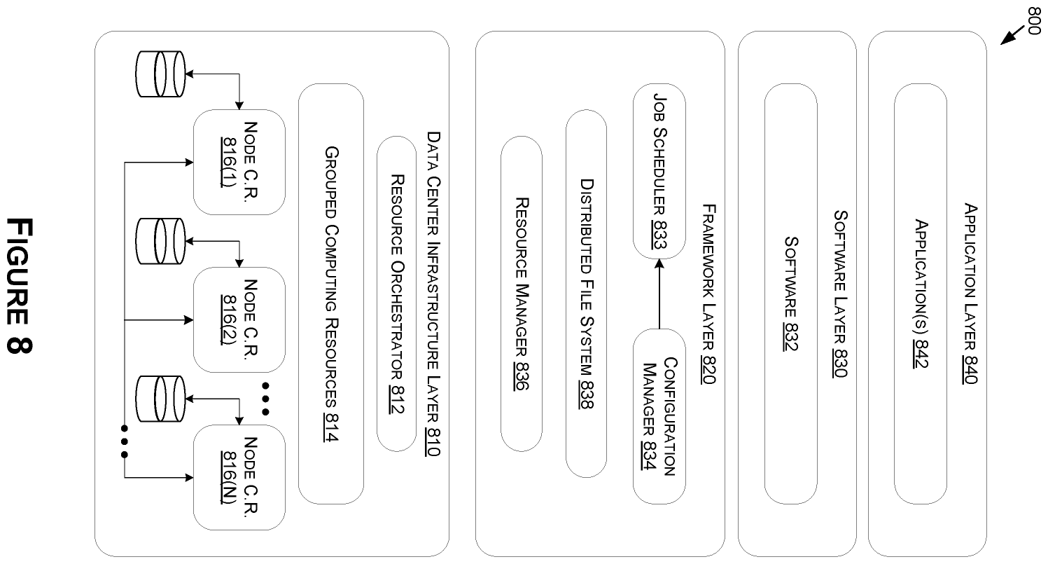

The process 100 may be implemented using, among other components, one or more machine learning models (MLMs) 102 and a training engine 104. The training engine 104 may include a parameter adjuster 106 and an output analyzer 108. The process 100 (and the components and/or features thereof) may be implemented using one or more computing devices, such as the computing device 700 of FIG. 7 and/or one or more data centers, such as the data center 800 of FIG. 8, described in more detail below.

At a high level, the process 100 may include the MLM(s) 102 receiving one or more inputs, such as one or more samples of a dataset(s) 110 (e.g., a training dataset), and generating one or more outputs, such as output data 112 (e.g., tensor data) from the one or more inputs. As indicated in FIG. 1, the dataset(s) 110 may be applied to the MLM(s) 102 by the training engine 104. The process 100 may also include the output analyzer 108 of the training engine 104 receiving one or more inputs, such as the output data 112, and generating one or more outputs, such as loss function data 114 (e.g., representing one or more losses for the one or more MLMs 102 with respect to one or more cost functions) from the one or more inputs. The parameter adjuster 106 may receive one or more inputs, such as the loss function data 114, and generate one or more outputs, such as update data 116 (e.g., representing updates to one or more values of one or more parameters of one or more of the MLMs 102) from the one or more inputs. The parameter adjuster 106 may apply the update data 116 to the MLM(s) 102 to update one or more values of one or more parameters of one or more of the MLMs 102 according to the update data 116. The process 100 may repeat any number of iterations, for example, until the MLMs 102 are fully trained. For example, the training engine 104 may determine to end training using any suitable approach, such as determining the MLMs 102 have converged (e.g., using the loss function data 114), determining a threshold number of training iterations have occurred, etc. The MLM(s) 102 may be deployed and/or subjected to additional verification, testing, and/or adaptation based at least on the determination.

The dataset(s) 110 may include training, verification, or testing data. For example, the dataset 110 may be used by the training engine 104 for training the MLM(s) 102, for verifying the MLM(s) 102, and/or for testing the MLM(s) 102. In one or more embodiments, the dataset(s) 110 may be applied to the MLM(s) 102 over a number of the iterations of the process 100. In one or more embodiments, the dataset 110 may represent one or more samples applied to the MLM(s) 102 by the training engine 104 in the process 100. The samples may correspond to at least one class having one or more attributes (e.g., an output class of one or more of the MLMs 102).

The MLM(s) 102 and other MLMs described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models. In various examples, an MLM may include one or more convolutional neural networks.

By way of example, and not limitation, the MLM(s) 102 may include one or more MLMs that the training engine 104 may train using adversarial learning. For example, the MLM(s) and/or portions thereof (e.g., layers, sub-networks, etc.) may be trained for competing tasks or functions.

As examples, such as where the machine learning model(s) 102 include at least one convolutional neural network (CNN), the machine learning model(s) 102 may include any number of layers. One or more of the layers may include an input layer. The input layer may hold values associated with the dataset(s) 110 (e.g., before or after post-processing). For example, when a sample in the dataset(s) 110 represents an image, the input layer may hold values representative of the raw pixel values of the image(s) as a volume (e.g., a width, a height, and color channels (e.g., RGB), such as 32×32×3).

One or more layers may include convolutional layers. The convolutional layers may compute the output of neurons that are connected to local regions in an input layer, each neuron computing a dot product between their weights and a small region they are connected to in the input volume. A result of the convolutional layers may be another volume, with one of the dimensions based on the number of filters applied (e.g., the width, the height, and the number of filters, such as 32×32×12, if 12 were the number of filters).

One or more of the layers may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers may include a pooling layer. The pooling layer may perform a down sampling operation along the spatial dimensions (e.g., the height and the width), which may result in a smaller volume than the input of the pooling layer (e.g., 16×16×12 from the 32×32×12 input volume).

One or more of the layers may include one or more fully connected layer(s). Each neuron in the fully connected layer(s) may be connected to each of the neurons in the previous volume. The fully connected layer may compute class scores, and the resulting volume may be 1×1×number of classes. In some examples, the CNN may include a fully connected layer(s) such that the output of one or more of the layers of the CNN may be provided as input to a fully connected layer(s) of the CNN. In some examples, one or more convolutional streams may be implemented by the machine learning model(s) 102, and some or all of the convolutional streams may include a respective fully connected layer(s).

In some non-limiting embodiments, the machine learning model(s) 102 may include a series of convolutional and max pooling layers to facilitate image feature extraction, followed by multi-scale dilated convolutional and up-sampling layers to facilitate global context feature extraction.

Although input layers, convolutional layers, pooling layers, ReLU layers, and fully connected layers are discussed herein with respect to the machine learning model(s) 102, this is not intended to be limiting. For example, additional or alternative layers may be used in the machine learning model(s) 102, such as normalization layers, SoftMax layers, gradient reversal layers, and/or other layer types.

In embodiments where the machine learning model(s) 102 includes a neural network, different orders and/or numbers of the layers of the neural network may be used depending on the embodiment. In other words, the order and number of layers of the machine learning model(s) 102 is not limited to any one architecture.

In addition, some of the layers may include parameters (e.g., weights and/or biases), such as the convolutional layers and the fully connected layers, while others may not, such as the ReLU layers and pooling layers. In some examples, the parameters may be learned by the machine learning model(s) 102 during training. Further, some of the layers may include additional hyper-parameters (e.g., learning rate, stride, epochs, etc.), such as the convolutional layers, the fully connected layers, and the pooling layers, while other layers may not, such as the ReLU layers. The parameters and hyper-parameters are not to be limited and may differ depending on the embodiment.

The output analyzer 108 of the training engine 104 may be configured to generate the loss function data 114 from the output data 112. The output data 112 may represent one or more outputs from one or more of the MLM(s) 102. In at least one embodiment, the output data 112 may include at least a portion of tensor data (and/or vector data, and/or scalar data) from one or more of the MLMs 102. The output analyzer 108 may generate the loss function data 114 based at least on analyzing the output data 112. The analysis of the output data 112 may be performed using various approaches. In at least one embodiment, the output analyzer 108 may post process at least some of the output data 112, for example, to determine one or more inferred or predicted outputs of one or more of the MLMs 102 (e.g., one or more outputs the MLM 102 is trained to or is being trained to infer). The output analyzer 108 may analyze the post processed data to determine the loss function data 114. For example, the output analyzer 108 may include one or more optimizers or solvers that the training engine 104 may use to define how to change the parameters of one or more of the MLM(s) 102—such as weights and learning rate—in order to reduce loses according to a loss or cost function(s).

In one or more embodiments, the output analyzer 108 may compute, using the output data 112, multiple gradients corresponding to one or more cost functions, where the gradients are of different orders. For example, the output analyzer 108 may compute at least a first gradient and a second gradient, where the second gradient has a higher order than the first gradient. In one or more embodiments, the first gradient may be a first order gradient of a cost function and the second gradient may be a second order gradient of the cost function. However, in various examples, the gradients may be of any order (e.g., first four, second and fourth, first and third, etc.).

The parameter adjuster 106 may be configured to generate one or more outputs, such as the update data 116 from the loss function data 114. For example, the parameter adjuster 106 may use the gradients computed using the output analyzer 108 to determine updated values of one or more parameters for one or more of the MLM(s) 102.

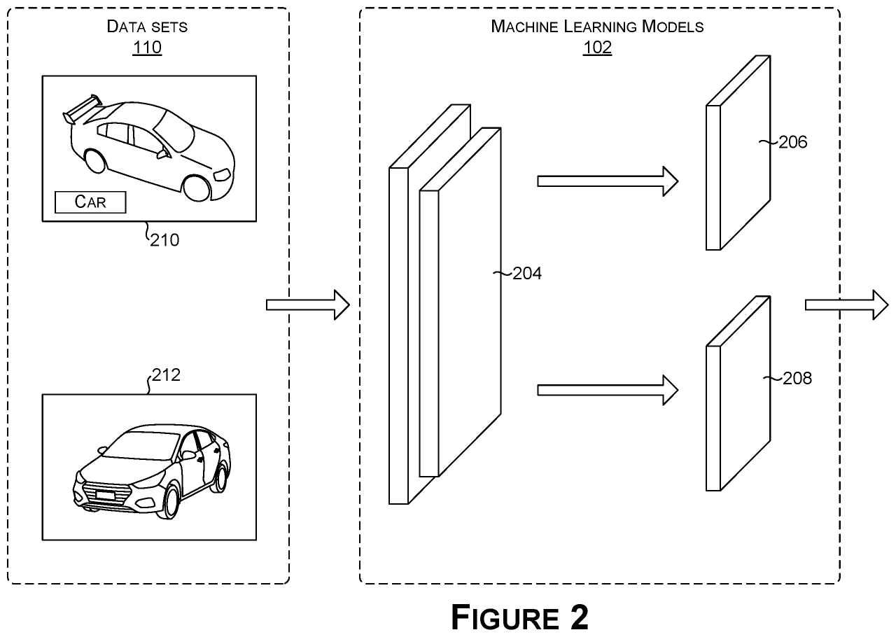

Referring now to FIG. 2, FIG. 2 illustrates examples of neural networks 204, 206, 208 of the MLMs 102 and the datasets 110 which may be used in domain-adversarial learning, in accordance with some embodiments of the present disclosure. In particular, the process 100 may employ the datasets 110 and the MLMs 102 shown in FIG. 2 for domain-adversarial learning (DAL).

The datasets 110 include a dataset 210 and a dataset 212. By way of example, the dataset 210 may correspond to a labeled source domain and the dataset 212 may correspond to an unlabeled target domain. By way of example, and not limitation, the dataset 210 may correspond to synthetic data and the dataset 212 may correspond to real-world data. In the example shown, the dataset 210 comprises synthetic renderings of 3D models of objects (e.g., models of vehicles) and the dataset 212 comprises real-world images of objects (e.g., photographs of vehicles).

The process 100 may be used to transfer knowledge (e.g., encoded by the labels) from the first domain (e.g., synthetic) to the second domain (e.g., real-world) in a representation space learned by the MLMs 102. To do so, the process 100 may be used to implement DAL. Using DAL, the MLMs 102 may learn domain invariant representations of inputs in an adversarial fashion.

As shown, the MLMs 102 include the neural network(s) 204 (e.g., a feature extractor), which may be trained to generate a representation of one or more features that is invariant to a first domain corresponding to the dataset 210 input to the MLMs 102 and a second domain corresponding to the dataset 212 input to the MLMs 102.

The MLMs 102 may also include the neural network(s) 206 (e.g., a classifier), which may be trained to use the data corresponding to features of the one or more features that are generated using the neural network 204 to perform an inference task—which may be used during deployment of the MLMs 102 to control one or more parameters of a machine, such as an autonomous vehicle, a robot, an application on a computer, etc., or for another purpose. In at least one embodiment, the training engine 104 may use one or more ground-truth labels assigned to samples of the dataset 210 to train the neural network 206. However, ground-truth labels may not be available for the dataset 212 when training.

The MLMs 102 may further include the neural network(s) 208 (e.g., a domain classifier), which may be trained to classify or otherwise generate data indicating whether the representation produced using the neural network 204 corresponds to the first domain or the second domain (e.g., the dataset 210 or the dataset 212).

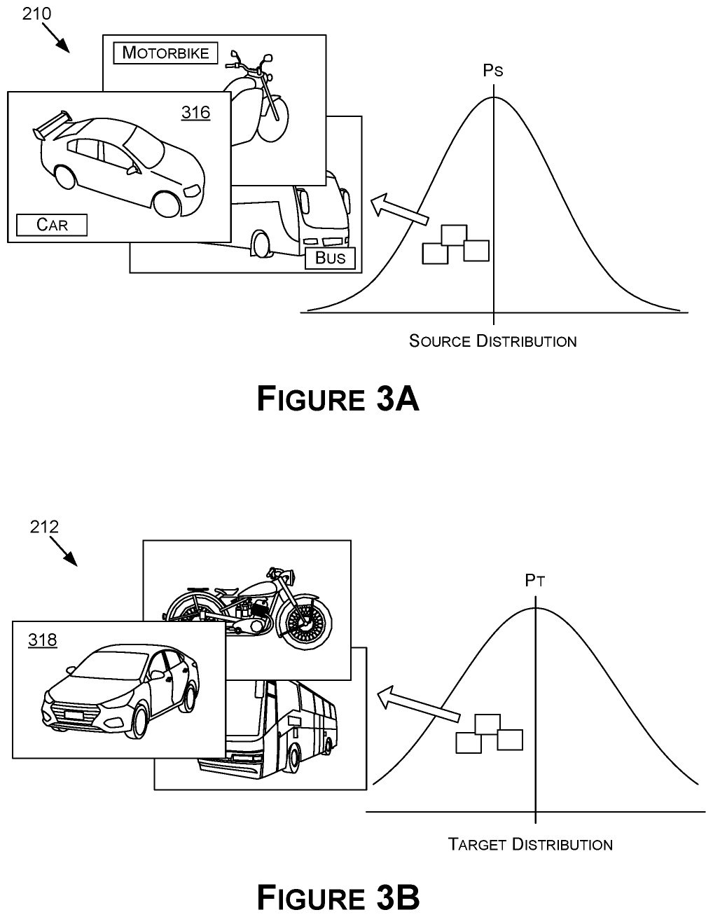

Referring now to FIG. 3A and FIG. 3B with FIG. 2, FIG. 3A illustrates an example of a dataset distribution Pₛ of a source domain, and FIG. 3B illustrates an example of a dataset distribution Pₜ of a target domain, in accordance with some embodiments of the present disclosure.

In one or more embodiments, to train the MLMs 102, the training engine 104 may have access to and use labeled examples, such as a sample 316, for the dataset 210, while the dataset 212 may provide unlabeled examples, such as a sample 318. Source inputs X^{s} from the dataset 212 may be sampled from the dataset distribution Pₛ and target inputs Xⁱ from the dataset 210 may be sampled from the dataset distribution Pₜ, both over X The training engine 104 may be configured to find a hypothesis that jointly minimizes the risk in the target domain corresponding to the dataset distribution Pₜ using labeled examples from the source domain corresponding to the dataset distribution Pₛ. For example, the training engine 104 may be configured to find a function such that, in combination with the neural network 206, the function minimizes the risk of the source domain and its composition with the neural network 206, and such that the neural network 208 minimizes the divergence of the dataset distribution Pₜ and the dataset distribution Pₛ. The computation of the divergence may be estimated by the neural network 208 using domain classification to detect whether a sample belongs to the source or target domain. When there does not exist a function that can properly distinguish between source and target domain samples, the MLMs 102 may be considered fully invariant to the domains.

In training the MLMs 102, the training engine 104 may be configured to selfishly minimize each neural network's cost function. The adversarial nature of the learning algorithm may result from the introduction of a gradient reversal layer (GRL) in the neural network(s) 208. During backpropagation, the GRL may take the gradient from the subsequent level and change its sign—e.g., multiply the gradient by −1—before passing it to the preceding layer. Flipping the sign of the gradient during a backward pass may have strong implications on the training dynamics and asymptotic behavior of the learning algorithm employed by the training engine 104. For example, the GRL may transform gradient descent into a competitive gradient-based algorithm, which may converge to periodic orbits and other non-trivial limiting behavior that arise, for instance, in chaotic systems. This is in contrast to conventional techniques where the implicit regularization introduced by gradient descent has been shown to be desirable.

Optimal solutions in adversarial training may correspond to Nash Equilibria. A global Nash Equilibria (NE) may not always exist, for example, where the losses are not convex or concave. In one or more embodiments, the training engine 104 may train the MLM(s) 102 based at least on determining convergence of values of the one or more parameters of the adversarial neural networks to a local Nash Equilibria. For example, in DAL and other adversarial learning approaches, an optimal solution may correspond to a local Nash Equilibria. An NE may mean that no neural network in the MLMs 102 is to have its parameters changed because it will not result in any additional performance gain.

Gradient descent could be used to train the MLMs 102 using DAL. Using gradient descent with a GRL may violate the asymptotic convergence guarantees to local NE unless an upper bound is placed on the learning rate. This may explain why using gradient descent can result in training instability and sensitivity to optimizer parameters if the learning rate is too high. While the learning rate may be kept low, this may result in long training times with additional computational processing and training iterations.

In accordance with aspects of the disclosure, the output analyzer 108 may implement one or more higher-order ordinary differential equation (ODE) solvers, which may ameliorate constraints which may result from gradient descent for various embodiments of the MLM(s) 102. For example, where the training of the MLMs 102 is adversarial in nature, such as in DAL, constraints on learning rate imposed by the ODE may be improved (e.g., eliminated). In one or more embodiments, a higher-order ODE solver employed by the output analyzer 108 may be a higher-order gradient descent/Euler Method solver, a higher-order Runge-Kutta solver, and/or other type of higher-order ODE solver.

Given the existence of a strict local NE, the gradient-play dynamics may be attracted to the strict local NE. This condition implies that the NE is structurally stable and disclosed approaches may benefit from this characteristic. Structural stability implies that slightly biased estimators of the gradient (e.g., due to sampling noise) have similar behaviors in neighborhoods of equilibria. However, in practice, this assumption may not hold, and it may be computationally hard to verify. Despite this, noticeable performance gains may be achieved for many different tasks, benchmarks, and network architectures.

DAL may aim to fool a classifier that operates in a representation space that aims to classify whether a data point belongs to either the source or the target domain. More formally, DAL may be understood as training to minimize the discrepancy between a source domain(s) and a target domain(s) in a representation space. In practice, an explicit solution of the ODE may not be possible. Thus, the output analyzer 108 may employ integration algorithms to approximate the solution. Training an MLM may employ the Euler method corresponding to Equation (1):

ω⁺=ω−ην(ω) (1)

where ν(ω) refers to the vector field of the joint parameter set w for the MLMs 102, and ω⁺ refers to an update for the joint parameter set w, which may correspond to the update data 116, and η refers to the learning rate. This approach may be referred to as gradient descent, as described herein.

A high resolution ODE based on gradient descent using a GRL may take the form of Equation (2):

$$\dot{ω} = - v ( ω ) - \frac{η}{2} ∇ v ( ω ) v ( ω ) \qquad ( 2 )$$

While conventionally the term following −ν(ω) was thought of as beneficial for supervised learning, in various scenarios, such as in adversarial learning, it may result in a Jacobian of dynamics that introduces an upper bound on the learning rate. Using disclosed approaches, this term may be effectively nullified.

Using a Runge-Kutta method, for example, with a second order, an ODE based on gradient descent may take the form of Equation (3):

$${ω}^{+} = ω - \frac{η}{2} ( v ( ω ) + v ( ω - η v ( ω ) ) ) \qquad ( 3 )$$

Comparing Equation (3) to Equation (1), it is apparent that Equation (3) may be implemented in a straightforward manner using standard deep learning frameworks. Moreover, it does not need to introduce any additional hyper-parameters, while approximating the continuous ODE with high precision.

Using a Runge-Kutta method, for example, with a fourth order, an ODE based on gradient descent may take the form of Equation (4):

$${ω}^{+} = ω - \frac{η}{6} ( v ( ω ) + 2 {v}_{2} ( ω ) + 2 {v}_{3} ( ω ) + {v}_{4} ( ω ) ) , \qquad ( 4 )$$

where according to Equation (5):

$${v}_{2} ( ω ) = v ( ω - \frac{η}{2} v ( ω ) ) , {v}_{3} ( ω ) = v ( ω - \frac{η}{2} {v}_{2} ( ω ) ) , {v}_{4} ( ω ) = v ( ω - η {v}_{3} ( ω ) ) , \qquad ( 5 )$$

is in accordance with Equation (6):

\dot{ω}=−ν(ω)+O(η⁴). (6)

As can be seen by Equations (3) and (4), disclosed approaches may update parameters based at least on a statistical combination of the gradients, such as an average (e.g., weighted average), or other statistical combination.

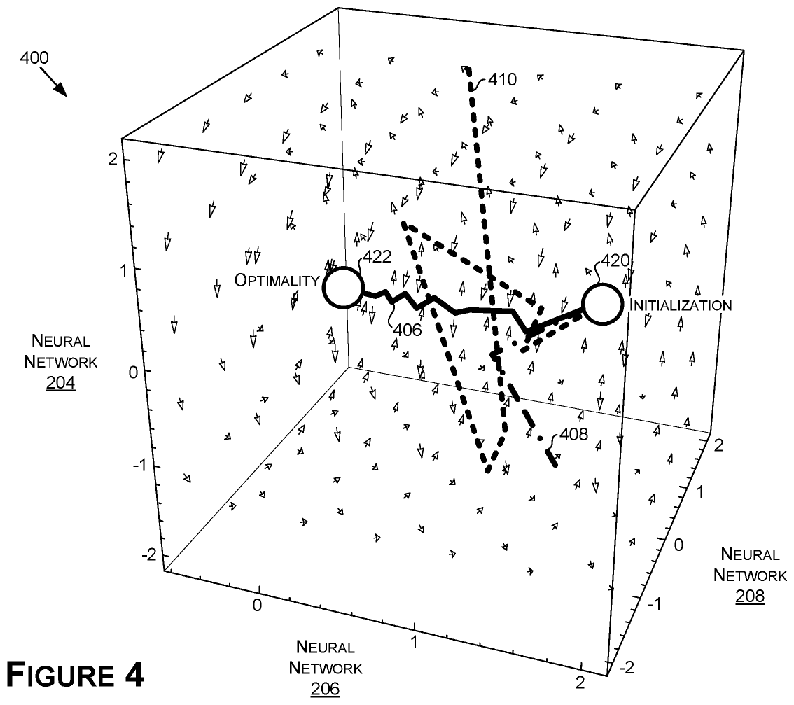

Referring now to FIG. 4, FIG. 4 is an example graph 400 of parameter values in jointly trained neural networks for various forms of optimizers, in accordance with some embodiments of the present disclosure. The graph 400 includes parameter values 406 for the MLMs 102 over training iterations performed using the training engine 104 while implementing a multi-order ODE solver, as described herein. The graph 400 also includes parameter values 408 and 410 for the MLMs 102 over training iterations performed while implementing first-order ODE solvers. As can be seen the parameter values 406 progress from initialization 420 to optimality 422 in a faster and more direct manner than the parameter values 408 and 410 for first-order ODE solvers, which may never reach a state of optimality 422 or convergence.

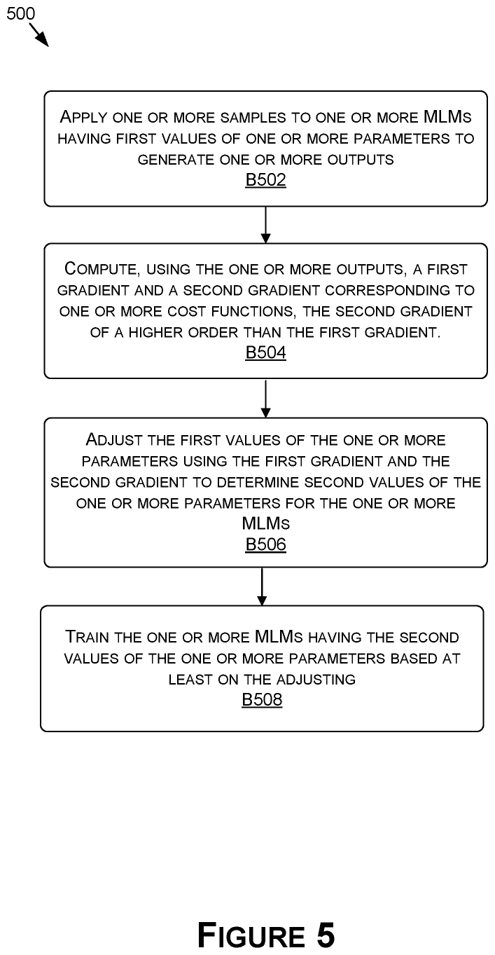

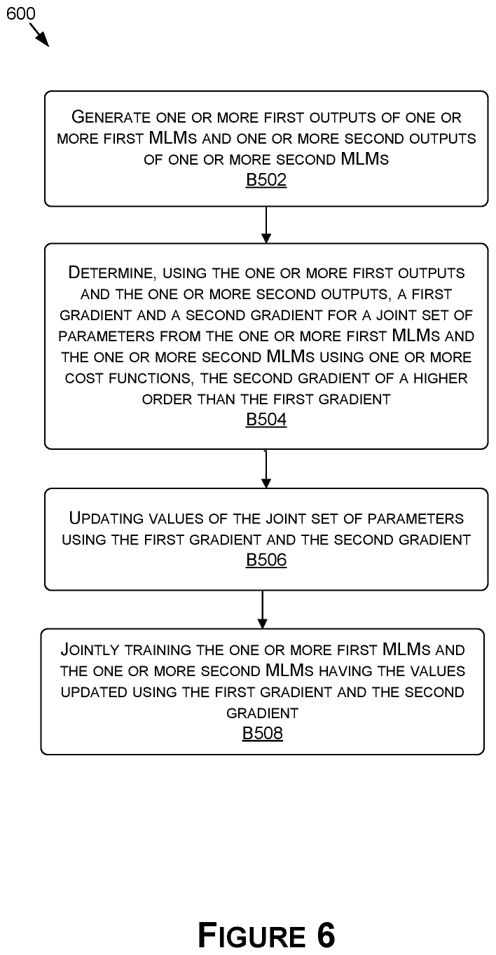

Now referring to FIGS. 5-6, each block of methods 500 and 600, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 500 and 600 are described, by way of example, with respect to FIGS. 1 and 2. However, the methods 500 and 600 may additionally or alternatively be executed by any one system, or any combination of systems, including, but not limited to, those described herein.

FIG. 5 is a flow diagram showing a method 500 for training one or more MLMs using at least a first gradient and a second gradient, in accordance with some embodiments of the present disclosure.

The method 500, at block B502, includes applying one or more samples to one or more MLMs having first values of one or more parameters to generate one or more outputs. For example, the training engine 104 may apply one or more samples corresponding to the dataset(s) 110 to the MLMs 102 having first values of one or more parameters to generate one or more outputs corresponding to the output data 112.

The method 500, at block B504, includes computing, using the one or more outputs, a first gradient and a second gradient corresponding to one or more cost functions, the second gradient of a higher order than the first gradient. For example, the output analyzer 108 may compute, using the output data 112, a first gradient and a second gradient corresponding to one or more cost functions (e.g., according to Equations (3) or (4)).

The method 500, at block B506, includes adjusting the first values of the one or more parameters using the first gradient and the second gradient to determine second values of the one or more parameters for the one or more MLMs. For example, the parameter adjuster 106 may adjust the first values of the one or more parameters using the first gradient and the second gradient to determine second values of the one or more parameters for the MLM(s) 102. The second values of the one or more parameters may correspond to the update data 116.

The method 500, at block B508, includes training the one or more MLMs having the second values of the one or more parameters based at least on the adjusting. For example, the method 500 may repeat for training the MLM(s) 102 having the second values of the one or more parameters based at least on the adjusting.

Referring now to FIG. 6, FIG. 6 is a flow diagram showing a method 600 for jointly training MLMs using at least a first gradient and a second gradient, in accordance with some embodiments of the present disclosure.

The method 600, at block B602, includes generating one or more first outputs of one or more first MLMs and one or more second outputs of one or more second MLMs. For example, the training engine 104 may generate at least one or more first outputs of the neural network 204 and one or more second outputs of the neural network 208 (e.g., using the one or more first outputs).

The method 600, at block B604, includes determining, using the one or more first outputs and the one or more second outputs, a first gradient and a second gradient for a joint set of parameters from the one or more first MLMs and the one or more second MLMs using one or more cost functions, the second gradient of a higher order than the first gradient. For example, the output analyzer 108 may compute, using the one or more first outputs and the one or more second outputs, a first gradient and a second gradient corresponding to one or more cost functions (e.g., according to Equations (3) or (4)).

The method 600, at block B606, includes updating values of the joint set of parameters using the first gradient and the second gradient. For example, the parameter adjuster 106 may adjust values of the joint set of parameters using the first gradient and the second gradient. The values of the joint set of parameters may correspond to the update data 116.

The method 600, at block B608, includes jointly training the one or more first MLMs and the one or more second MLMs having the values updated using the first gradient and the second gradient. For example, the method 600 may repeat for jointly training the neural network 204 and the neural network 208 having the values updated using the first gradient and the second gradient. In one or more embodiment, the method 600 further applies to jointly training the neural network 206 with the neural network 204 and the neural network 208.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 833, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 833 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 833. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating one or more outputs using one or more neural networks, the one or more neural networks comprising one or more parameters corresponding to one or more first values;
computing, using one or more cost functions and based at least on the one or more outputs, a first gradient and a second gradient being of a higher order than the first gradient; and
adjusting the one or more first values corresponding to the one or more parameters using the first gradient and the second gradient to determine one or more second values corresponding to the one or more parameters for the one or more neural networks.

2. The method of claim 1, wherein the one or more neural networks include a first neural network and a second neural network, the first neural network and the second neural network are trained using adversarial training.

3. The method of claim 1, wherein the one or more neural networks include a plurality of neural networks and the plurality of neural network are trained, at least in part, by:
training at least one first neural network of the plurality of neural networks to generate a representation of one or more features that is invariant to a first domain corresponding to a first dataset input to the at least one first neural network and a second domain corresponding to a second dataset input to the at least one first neural network; and
training at least one second neural network of the plurality of neural networks to classify whether the representation corresponds to the first domain or the second domain.

4. The method of claim 3, wherein the first domain corresponds to synthetic data and the second domain corresponds to real-world data.

5. The method of claim 3, further comprising training, using one or more ground-truth labels assigned to the first dataset, at least one third neural network of the plurality of neural networks to classify the representation.

6. The method of claim 1, wherein the adjusting the one or more first values corresponding to the one or more parameters is based at least on a statistical combination of at least the first gradient and the second gradient.

7. The method of claim 1, wherein the first gradient is a first order gradient of the one or more cost functions and the second gradient is a second order gradient of the one or more cost functions.

8. The method of claim 1, wherein the one or more neural networks include one or more adversarial neural networks and the training includes determining convergence of the one or more parameters of the one or more adversarial neural networks to a local Nash Equilibria.

9. The method of claim 1, wherein the one or more neural networks include a gradient reversal layer.

10. The method of claim 1, further comprising using the one or more neural networks to perform one or more operations within a system, the system comprising or being comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

11. A system comprising:
one or more processing units to:
generate one or more first outputs of one or more first neural networks and one or more second outputs of one or more second neural networks;
determine, using one or more cost functions and based at least on the one or more first outputs and the one or more second outputs, a first gradient and a second gradient for a joint set of parameters of the one or more first neural networks and the one or more second neural networks, the second gradient being of a higher order than the first gradient; and
update values of the joint set of parameters using the first gradient and the second gradient.

12. The system of claim 11, wherein the values of the joint set of parameters are updated by:
updating one or more first parameters of the one or more first neural networks to generate a representation of one or more features that is invariant to a first domain corresponding to a first dataset input to the one or more first neural networks and a second domain corresponding to a second dataset input to the one or more first neural networks; and
updating one or more second parameters of the one or more second neural networks to classify whether the representation corresponds to the first domain or the second domain.

13. The system of claim 12, wherein the one or more processing units are further to train, using one or more ground-truth labels assigned to the first dataset, one or more third neural networks to classify the representation.

14. The system of claim 12, wherein the values are updated based at least on a statistical combination generated using the first gradient and the second gradient.

15. The system of claim 12, wherein the one or more processing units are further to perform one or more operations using the one or more neural networks, the system comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

16. A processor comprising:
one or more circuits to perform one or more operations using one or more neural networks, the one or more neural networks trained by, at least in part, updating one or more values of one or more parameters of the one or more neural networks using multi-order gradients corresponding to one or more cost functions.

17. The processor of claim 16, wherein the one or more neural networks include a plurality of neural networks and the updating the one or more values is performed using adversarial training amongst the plurality of neural networks.

18. The processor of claim 16, wherein the updating the one or more values includes transferring knowledge from a labeled source domain to an unlabeled target domain in a representation space learned by the one or more neural networks.

19. The processor of claim 16, wherein the one or more neural networks include a plurality of neural networks and the updating the one or more values of the one or more parameters includes:
updating one or more first parameters of one or more first neural networks of the plurality of neural networks to generate a representation of one or more features that is invariant to a first domain corresponding to a first dataset input to the one or more first neural networks and a second domain corresponding to a second dataset input to the one or more first neural networks; and
updating one or more second parameters of one or more second neural networks of the plurality of neural networks to classify whether the representation corresponds to the first domain or the second domain.

20. The processor of claim 16, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
